(19) United States
(12) Patent Application Publication
(10) Pub. No.: US 2009/0176460 A1
(43) Pub. Date: Jul. 9, 2009

(54) PTT mode telecommunication method and system, management module, servers, program and data recording medium for said system

(76) Inventors: Thibaud Mienville, Paris (FR); Diego Anza, Paris (FR); Aude Pichelin, Issy Les Moulineaux (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/921,529

(22) PCT Filed: Jun. 6, 2006
(86) PCT No.: PCT/FR2006/050521

§ 371 Date: Mar. 5, 2009

(30) Foreign Application Priority Data
Jun. 3, 2005 (FR) 0505651

(51) Int. Cl. H04B 1/38

(52) U.S. Cl. 455/90.2

(57) ABSTRACT

This PTT (Push-To-Talk) mode telecommunications system linking users of a wireless telephone network includes a management module (26) which can determine the rights of the participants to participate in and talk in a PTT session as a function of the telecommunications service quality level used by each user to participate in the PTT session and as a function of a predefined telecommunications service quality level required to participate in that PTT session.

The present invention relates to a PTT mode telecommunications method and system, a management module, servers, a program and a data storage medium for said system.

In simple terms, a PTT (Push-To-Talk) mode communications system or method sets up a PTT session that enables two or more participants to use their telephone terminals as walkie-talkies. The connections between the participants are then in half-duplex mode. To speak, a participant A presses a key on the terminal, and holds it down while speaking. During this time, the other participants can only listen. When participant A releases the key, the terminal no longer transmits to the other participants. Either of the other participants B or C can then speak by pressing the corresponding key on their terminals.

Existing PTT mode communications systems include:
wireless terminals usable under the control of a user to participate in a Push-To-Talk session; and
a Push-To-Talk server connected to the terminals via a wireless network, this server being adapted to manage said Push-To-Talk session.

Those systems work correctly. However, different participants may use different access networks and terminals, with the result that the telecommunications service quality levels available to or chosen by different participants can be different. The quality level perceived by a telecommunications service user is defined here as the ability of the terminal and the access network to reproduce without deterioration words spoken by a user into a terminal, how quickly the words spoken are routed by the terminal and the access network to the PTT server (often expressed by a latency time: the shorter the latency time, the faster the spoken words are transmitted), and/or the time necessary to set up the Push-To-Talk session or to be able to speak in a session that has already been set up.

These criteria are concurrent and illustrate how users perceive quality of service at the application level.

During a PTT session, participants A and B can have a very good quality level, whereas participant C in the same PTT session might have a mediocre level of quality. Under such circumstances, when participants A and B are listening to participant C speaking, the words spoken by participant C are reproduced badly and can have a long latency time because they are routed via the terminal and the access network of participant C. Thus participants A and B perceive a low level of quality when participant C is speaking even though they are paying for a high level of quality. This can prove disagreeable for participants A and B.

The invention aims to remove this drawback by proposing a PTT mode communications system that can avoid participants in a PTT session perceiving at the application level the consequences of heterogeneous quality levels of the telecommunications services used by each of the participants.

The invention therefore consists in a PTT mode telecommunications system including a management module adapted to select a mode of restricted participation in said Push-To-Talk session during the setting up of said Push-To-Talk session as a function of an available or selected quality of service level and as a function of a predefined quality of service level for said push-to-talk session.

The management module can restrict the participation of a user as a function of the level of quality available or chosen by that user for participating in the PTT session. The other participants are then less aware of and are less inconvenienced by the poor quality level of the telecommunications service used by one of the participants. This makes the PTT session more user friendly for the other participants.

In one embodiment, the restricted participation mode prohibits a user from speaking during said push-to-talk session. This has the advantage that the user whose participation is restricted cannot speak.

Embodiments of this system can have one or more of the following features:
said prohibition allows said user prohibited from speaking to listen to participants in the Push-To-Talk session;
the management module is adapted to compare a current quality of service level used by the user to the predefined level and automatically to prohibit that user from speaking if the current quality level that has been acquired is lower than the predefined level;
the management module is adapted to compare the current quality of service level used by the user to the predefined level and to prohibit that user from speaking if the current quality level that has been acquired is lower than the predefined level and in response to a rejection instruction sent by one of the participants in the Push-To-Talk session;
said restricted participation mode prohibits adding a user to a definition of a group of participants in the Push-To-Talk session if the quality of service level that is available or has been chosen is lower than the predefined level for said Push-To-Talk session.

Embodiments of this system have the following advantages:
authorizing the user to listen to the participants in the PTT session without being able to speak maintains a high quality level between the participants without totally excluding those who do not have as high a quality level;
comparing the current quality level that is available or has been chosen by each user to the predefined level when setting up each PTT session means that the condition for access to the PTT session can be updated for each participant;
prohibiting adding a user to a group of participants in a PTT session prevents that user from participating in that PTT session.

The invention further consists in:
a management module adapted to be used in a telecommunications system, characterized in that it is adapted to select a mode of restricted participation in a push-to-talk session during the setting up of said push-to-talk session as a function of an available or selected quality of service level and as a function of a predefined quality of service level for said push-to-talk session;
a push-to-talk server characterized in that it is adapted to send a predefined quality of service level to terminals of users seeking to participate in a push-to-talk session;
a group administration server adapted to be used in a telecommunications system, characterized in that it is adapted to create definitions of groups of participants in a push-to-talk session, said definitions containing a predefined quality of service level.

The invention further consists in a communications method employing:
wireless terminals usable under the control of a user to participate in a push-to-talk session; and
a push-to-talk server connected to the terminals via a wireless network, this server being adapted to manage said push-to-talk session;
characterized in that this method includes a step of selecting a mode of restricted participation in said push-to-talk session during the setting up of said push-to-talk session as a function of an available or selected quality of service level and as a function of a predefined quality of service level for said push-to-talk session.

Implementations of this method can have one or more of the following features:
said restricted participation mode consists in prohibiting a user from speaking during the push-to-talk session;
said prohibition allows said user who has been prohibited from speaking to listen to the other users participating in the Push-To-Talk session;

the method includes:
a step of comparing the current quality of service level used by the user to a predefined level; and
if the current quality level is lower than the predefined level, the step of automatically selecting a restricted participation mode;

the method includes:
a step of comparing the current quality of service level used by the user to the predefined level; and
if the current quality level is lower than the predefined level, the step of selecting a restricted participation mode is executed in response to a rejection instruction sent by one of the participants in the Push-To-Talk session;
said restricted participation mode prohibits adding a user to a definition of a group of participants in said Push-To-Talk session if the level of quality of service available or chosen for participating in said session is below the predefined level.

The invention further consists in:
a computer program characterized in that it includes instructions for executing a method as described above when said instructions are executed by a computer;
a server including a management module, characterized in that said module is adapted to select a mode of restricted participation in a Push-To-Talk session during the setting up of said Push-To-Talk session as a function of an available or selected quality of service level and as a function of a predefined quality of service level for said Push-To-Talk session;
a terminal including a management module, characterized in that said module is adapted to select a mode of restricted participation in a Push-To-Talk session during the setting up of said Push-To-Talk session as a function of an available or selected quality of service level and as a function of a predefined quality of service level for said Push-To-Talk session;
a terminal as described above, characterized in that said module is adapted to read said quality of service level from a memory.

The invention can be better understood on reading the following description, given by way of example only and with reference to the drawings, in which:

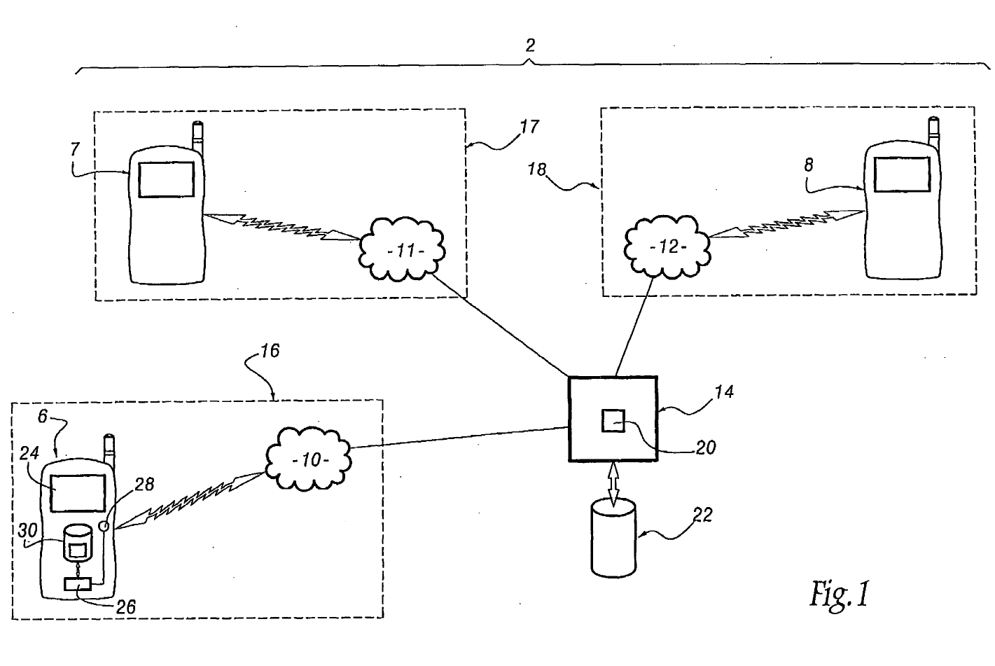

FIG. 1 is a diagrammatic illustration of the architecture of a PTT mode telecommunications system;

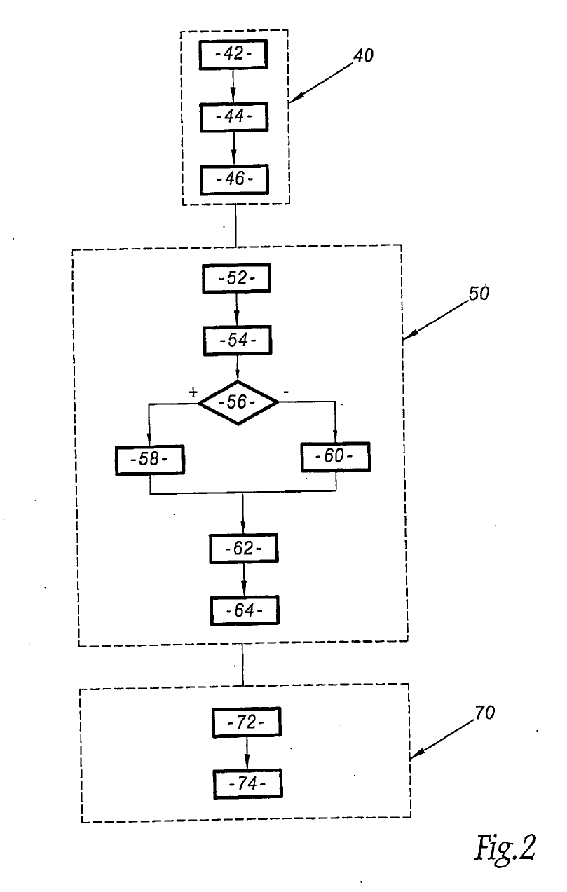

FIG. 2 is a flowchart of a PTT mode telecommunications method;

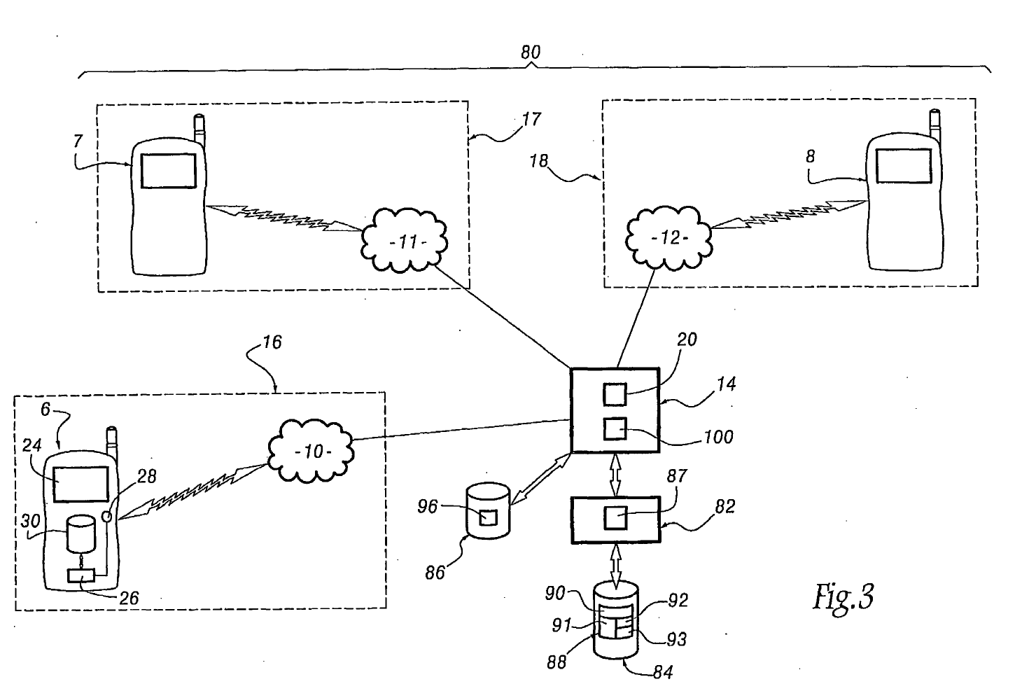

FIG. 3 is a diagrammatic illustration of the architecture of another PTT mode telecommunications system; and

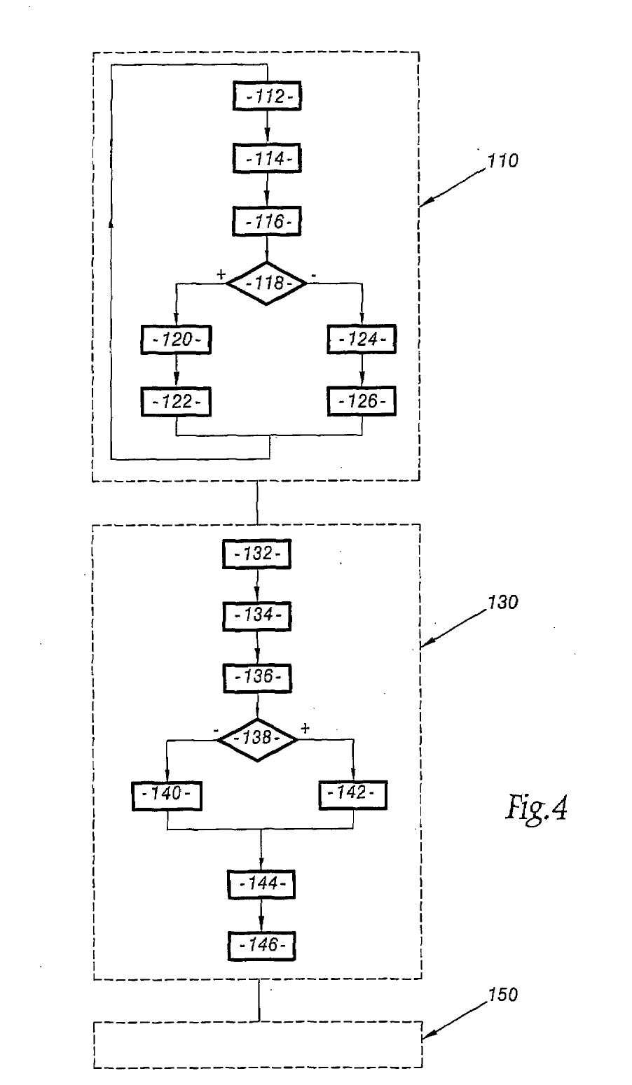

FIG. 4 is a flowchart of another PTT mode telecommunications method.

FIG. 1 represents a PTT mode telecommunications system 2 based on a cellular wireless telephone network. The general architecture of these systems, known as PoC (Push-To-Talk over Cellular) systems, is disclosed, for example, in draft standards drawn up by the OMA (Open Mobile Alliance). These systems are based on the Session Initiation Protocol (SIP) and the Real Time Protocol (RTP).

FIG. 1 shows only the elements necessary for understanding the invention.

The system 2 comprises a plurality of wireless telephone terminals 6, 7, 8 that can be used to participate in a PTT session.

Here, by way of illustration, each of the terminals 6 to 8 is connected to a PTT server 14 via a respective access network 10 to 12.

The network 10 is a 3G (3^{rd} generation) mobile telephone network, for example, such as a UMTS (Universal Mobile Telecommunications System) network, for example.

The network 11 is a 2G (2^{nd} generation) wireless telephone network, for example, such as a GSM (Global System for Mobile communications) network, for example.

The network 12 is a wireless local area network, such as a WiFi network.

The core networks are not shown in FIG. 1.

The combination of a terminal and its access network is referred to here as access means to the server 14. FIG. 1 shows access means 16 to 18, respectively corresponding to the combination of the terminal 6 and the network 10, the combination of the terminal 7 and the network 11, and the combination of the terminal 8 and the network 12.

The server 14 manages the setting up and conduct of a PTT session between the terminals.

In particular, here it includes a control module 20 for managing communication in half-duplex mode between the terminals of the participants in a PTT session. The functions of this module 20 are described in more detail with reference to FIG. 2.

For example, the server 14 is based on conventional programmable computers able to execute instructions stored on an information storage medium. To this end, a memory 22 connected to the server 14 contains instructions for executing the FIG. 2 method when those instructions are executed by the server 14.

The terminals 6 to 8 are identical, for example, and thus only the terminal 6 is described in detail.

For example, the terminal 6 is a mobile telephone equipped with a man/machine interface 24 in the form of a keypad and a screen.

The terminal 6 also includes a PTT session management module 26 associated with a key 28 of the terminal 6 that can be pressed to speak during a PTT session. The module 26 is able to restrict a user's participation in a PTT session as a function of the quality level of the access means used by that user and a quality level defined beforehand, at the latest when setting up the PTT session.

For example, the terminal 6 is also based on conventional programmable computers able to execute instructions stored on an information storage medium. To this end, it includes a memory 30 containing instructions for executing the FIG. 2 method when those instructions are executed by the electronic computer.

By way of illustration, the quality level available to or chosen by the user for participating in a PTT session is stored in the memory 30.

The quality level perceived by the user is a function in particular of the available access network (packet-switched network, circuit-switched network, etc.) and quality of service profiles used and available in the access network (such as UMTS classes of quality of service, for example).

Several types of quality of service level at the application level can be used:
a maximum quality level authorized for a user by their subscription (thus depending on options of the subscription that the user takes out with the operator, for example: business use, consumer use, premium use, etc.);
a quality level defined when setting up the PTT session, either by the user via their terminal or by default on the basis of the characteristics of the user's subscription if the user does not indicate anything to the contrary;
a quality level available at the current time t, depending on the user's subscription and also on the access network(s) available, the network resources available, the type of terminal, etc.;
a quality level assigned to a group for managing the participants.

The operation of the system 2 is described below with reference to the method shown in FIG. 2 where a user A of the terminal 6 wishes to communicate in PTT mode with users B and C of the terminals 7 and 8, respectively.

The process begins with a stage 40 of configuring the group of participants in the PTT session.

During this stage 40, in a step 42, user A selects the telephone numbers of the users A wishes to participate in the PTT session. It is assumed here that the telephone numbers of the terminals 7 and 8 are selected.

Then, during a step 44, the module 26 selects a minimum predefined telecommunications service quality level for the access means used by the participants in the PTT session. Here that predefined level is selected automatically by the module 26 on the basis of information relating to the subscription of user A. Alternatively, the predefined level can be acquired by the terminal 6 via the man/machine interface 24. A further alternative is for this predefined level to be made equal by default to the current quality level of the access means 16 used by user A.

During a step 46, a restricted participation mode is selected by the module 26. Here it is selected automatically by the module 26 as a function of information on the subscription of user A. It could instead be acquired via the interface 24.

The restricted participation mode limits how often and for how long a participant can speak if they are using access means for which the telecommunications service quality level is below the predefined quality level.

It is assumed here that the restricted participation mode selected is a mode in which a participant can only listen and not speak at all.

A stage 50 of setting up the PTT session between participants A to C is then executed.

During this stage 50, in a step 52, the terminal 6 sends the server 14 a “SIP Invite” instruction of the standardized Session Initialization Protocol (SIP), which is a signaling protocol used to set up telecommunications connections between telephone terminals.

The “SIP Invite” instruction also contains information specifying the medium, the codec and the bandwidth to be used, the predefined quality level, and an identifier of the restricted participation mode selected during steps 44 and 46. This additional information, i.e. the predefined quality level and the identifier of the restricted participation mode, are contained either in the header or in the body of the “SIP Invite” instruction.

During a step 54, the server 14 forwards the “SIP Invite” instruction to the terminals 7 and 8 via the access networks 11 and 12, respectively. The module 26 of each of the terminals 7 and 8 compares the quality level available to or chosen for the access means 17, 18 to the predefined level received in a step 56. To this end the available or chosen quality level is acquired beforehand by the module 26, which reads the available or chosen quality level in the memory 30, for example.

It is assumed here that the quality level of the access means 17 is higher than the predefined level, with the result that the terminal 7 proceeds automatically to a step 58 in which it selects the network 11 for communicating with the server 14.

By way of example, the access means 18 are assumed to have a quality level below the predefined quality level that has been received, with the result that, in a step 60, the module 26 of the terminal 8 automatically restricts the participation of user C in the PTT session to be set up. For example, the module 26 configures the terminal 8 so that its user cannot speak, for example by deactivating the key 28 of that terminal.

Then, in a step 62, the terminals 7 and 8 confirm that they are going to participate in the PTT session initiated by user A by sending a “SIP 200 OK” instruction to the server 14.

In response, in a step 64, the server 14 sends a “SIP 200 OK” instruction to the terminal 6 to confirm the participation of users B and C.

Once the PTT session has been set up between users A to C, they become participants in the session and can participate in a stage 70 of conversation in PTT mode.

For example, at the beginning of the stage 70, in a step 72, participant A presses the key 28 to speak and holds it depressed for as long as they continue to speak.

Their words are then transmitted to the terminals 7 and 8 via the networks 10, 11 and 12. During the step 72, participants B and C can only listen.

When participant A has finished speaking, they release the key 28.

Participant B can then speak in turn by pressing the key 28 on their terminal 7, in a step 74.

In contrast, the module 26 of the terminal 8 prevents participant C from speaking even if they press the key 28 on their terminal 8 at the right time.

Thus during the stage 70 participants A and B can speak only alternately using a half-duplex link, while participant C can only listen to the words spoken either by participant A or by participant B.

FIG. 3 represents another PTT mode telecommunications system 80 that differs from the system 2 in the presence of a group administration server 82 and memories 84, 86 respectively associated with the server 82 and the PTT server 14.

Elements in FIG. 3 already described with reference to FIG. 1 carry the same reference numbers. Only the new elements are described in detail.

The server 82 is adapted to create and manage definitions of groups of participants in PTT sessions. To this end it comprises a group administration module 87. The server 82 is connected to the memory 84.

The memory 84 contains definitions of groups. In terms of known characteristics, these group definitions conform, for example, to those described in the document PoC XDM (XML Document Management) specified by the OMA (OMA-TS-PoC XDM) with regard to the standard elements of that definition.

A definition 88 of a group X further contains an identifier 90 of the group and a list 91 of the participants in the group. Here the definition 88 also includes a field 92 containing the predefined quality level that the access means must provide and an identifier or definition 93 of the restricted participation mode.

The memory 86 is connected to the server 14 and includes a database 96 containing, in association with each user of the system 80, the quality level of the access means that the user employs to participate in a PTT session. That quality level stored in the database 96 is defined a priori as a function of the characteristics of the user's subscription, for example.

In addition to the control module 20, the server 14 includes a management module 100 the functions of which become apparent on reading the description with reference to FIG. 4.

The operation of the system 80 is described below with reference to the method represented in FIG. 4 and in the particular circumstance of setting up a PTT session using the access means 16 to 18.

Initially, one or more groups of participants must be configured during a stage 110. It is assumed here that an embryonic group of participants has already been created as described in the PoC XDM document.

In a step 112, the manager (or a manager) of group X sends the server 14 a request for user A to join group X. That request contains the identifier of group X.

In a step 114, the module 100 queries the server 82 to obtain the predefined quality level associated with group X.

In a step 116, the server 82 sends the module 100 the predefined quality level contained in the definition 88 of group X.

In a step 118, the module 100 then compares the quality level associated with user A in the database 96 to the predefined level that has been sent.

If the quality level associated with user A in the database 96 is higher than the predefined level that has been sent, then, in a step 120, the server 14 sends the server 82 an instruction to add user A to the list 91 of the definition 88 of group X. The server 82 then modifies the definition of group X accordingly and incorporates user A into the list 91.

After the step 120, in a step 122, the server 14 sends the manager of group X a confirmation of registration of user A as a member of group X.

If the quality level associated with user A is lower than the predefined level that has been sent, then, in a step 124, the module 100 prohibits adding user A to the list 91 of the definition of group X. Thereafter, in a step 126, the server 14 sends a registration refusal to the manager of group X.

It is assumed below that user A has been added to the list 91 of members of group X.

Later, anyone of the users on the list 91 may initiate a stage 130 of setting up a PTT session between the various participants in group X.

For example, in a step 132, participant A uses a terminal 6 to send an “SIP Invite” instruction to the server 14 including in addition to the various parameters of the session to be set up the identifier 90 of group X.

Then, in a step 134, the server 14 contacts the server 82 to recover the addresses (i.e. the telephone numbers here, for example) of the various participants on the list 91, together with the predefined quality level and the identifier or the definition of the restricted participation mode.

In a step 136, the module 20 sends an “SIP Invite” instruction to each of the participants on the list 91, this SIP Invite message containing in particular the predefined quality level 92 and the identifier or definition 93 of the restricted participation mode recovered in the step 134.

Then, in a step 138, the management module of each of the terminals that has received the “SIP Invite” instruction compares the current quality level of its own access means to the predefined level that has been received and proceeds either to a step 140 or to a step 142 as a function of the result of this comparison.

The steps 140 and 142 and the subsequent steps 144 and 146 are respectively identical to the steps 58, 60, 62, and 64, for example.

Once the PTT session has been set up, a stage 150 of conversation between the participants in PTT mode begins. This stage 150 is identical to the stage 70, for example.

Numerous other embodiments of the system and the method described above are possible. For example, the predefined quality level and the identifier or definition of the restricted participation mode can be exchanged between the terminals and the PTT server using DTMF tones instead of by means of the SIP.

The terminals have been described here as mobile telephones; they can instead be computers, fixed telephones, personal digital assistants (PDA) or any other wireless telephone terminals.

The functions of the PTT server and the group administration server can be combined in one and the same server or distributed across a multitude of servers.

Here the restricted participation mode is used only if the quality level of the access means used to participate in the PTT session is below the predefined level. However, a restricted participation mode can conversely be activated only for users employing access means having quality levels higher than the predefined level, so as to homogenize the quality level of the access means used by all the participants in a PTT session.

Alternatively, the restricted participation mode is not used, so that if there is a mismatch between the quality level as available or chosen and the predefined level, no participation of the user in the PTT session is allowed.

In another embodiment, the management module is adapted to warn participants A and B that user C does not have the required quality of service, leaving it to them to decide whether to accept or reject participation of said user in the Push-To-Talk session.

If one of participants A or B wishes to reject participation of that user then, under the control of user A or B, the management module 26 of participant A or B sends a reject instruction to the management module of user C.

Exclusively in response to this reject instruction, the management module of user C prohibits that user from speaking. User C is then either completely excluded from the PTT session or authorized to participate in the PTT session only in restricted participation mode.

The restriction steps described as implemented during the set-up stage can equally well be executed during the conversation stage instead, so as to adapt the restrictions imposed on the participants to the current quality level as measured and observed in real time for each participant.

Alternatively, the steps 138, 140, and 142 of the FIG. 4 method are omitted, so that the restriction step is executed only during the stage of configuring the group of participants.

The management module adapted to restrict the participation of a user in a PTT session can be implemented in each of the terminals or in the PTT server. It can equally well be implemented partly in the terminals and partly in the server 14 in the form of a client/server application.

Here, the current telecommunications service quality level is acquired by reading that level in the memory 30. Alternatively, this current quality level is acquired by measuring it at the time of setting up the PTT session. It is measured by the module 26, for example.

1. A telecommunications system comprising:
wireless terminals (6-8) usable under the control of a user to participate in a Push-To-Talk session;
a Push-To-Talk server (14) connected to the terminals via a wireless network, this server being adapted to manage said Push-To-Talk session; and
a management module (26; 100) adapted to select a mode of restricted participation in said Push-To-Talk session during the setting up of said Push-To-Talk session as a function of an available or selected quality of service level and as a function of a quality of service level predefined for said Push-To-Talk session.

2. The system according to claim 1, wherein said restricted participation mode prohibits a user from speaking during said Push-To-Talk session.

3. The system according to claim 1, wherein said restricted participation mode comprises prohibiting adding of a user to a definition of a group of participants in said Push-To-Talk session if the level of quality of service available or chosen is lower than the predefined level for said Push-To-Talk session.

4. A management module (26; 100) adapted to be used in a telecommunications system, wherein the management module is adapted to select a mode of restricted participation in a Push-To-Talk session during the setting up of said Push-To-Talk session as a function of a level of quality of service available or chosen and of a level of quality of service predefined for said Push-To-Talk session.

5. A Push-To-Talk server adapted to send a predefined quality of service level to terminals of users seeking to participate in a Push-To-Talk session.

6. A group administration server (82) adapted to be used in a telecommunications system (80), wherein the server is adapted to create definitions of groups of participants in a Push-To-Talk session, said definitions containing a predefined quality of service level.

7. A communications method employing wireless terminals (6-8) usable under the control of a user to participate in a Push-To-Talk session, and a Push-To-Talk server (14) connected to the terminals via a wireless network, this server being adapted to manage said Push-To-Talk session,
wherein the method comprises a step (60; 124, 142) of selecting a mode of restricted participation in said Push-To-Talk session during the setting up of said Push-To-Talk session as a function of a level of quality of service available or chosen and of a level of quality of service predefined for said Push-To-Talk session.

8. The method according to claim 7, wherein said restricted participation mode prohibits a user from speaking during the Push-To-Talk session.

9. The method according to claim 7, wherein said restricted participation mode prohibits adding a user to a definition of a group of participants in said Push-To-Talk session if the level of quality of service available or chosen for participating in said session is below the predefined level.

10. A computer program comprising instructions for executing a method according to claim 9, when said instructions are executed by a computer.

11. A server (14) including a management module (100) adapted to select a mode of restricted participation in a Push-To-Talk session during the setting up of said Push-To-Talk session as a function of a level of quality of service available or chosen and a level of quality of service predefined for said Push-To-Talk session.

12. A terminal (6-8) including a management module (26), wherein said module (26) is adapted to select a mode of restricted participation in a Push-To-Talk session during the setting up of said Push-To-Talk session as a function of a level of quality of service available or chosen and a level of quality of service predefined for said Push-To-Talk session.

13. The terminal (6, 7, 8) according to claim 12, wherein said module (26) is adapted to read said level of quality of service from a memory (30; 84).

14. A computer program comprising instructions for executing a method according to claim 7, when said instructions are executed by a computer.
